(19) United States
(12) Patent Application Publication
(10) Pub. No.: US 2022/0145679 A1
(43) Pub. Date: May 12, 2022

(54) HINGE ARRANGEMENT FOR A SWITCH CABINET AND A CORRESPONDING METHOD

(71) Applicant: RITTAL GMBH & CO. KG, Herborn (DE)

(72) Inventors: Carsten BÄUMER, Freudenberg (DE); Jacob HERR, Herborn (DE)

(73) Assignee: RITTAL GMBH & CO. KG, Herborn (DE)

(21) Appl. No.: 17/430,638

(22) PCT Filed: Jan. 9, 2020
(86) PCT No.: PCT/DE2020/100011

§ 371 Date: Aug. 12, 2021

(30) Foreign Application Priority Data
Feb. 18, 2019 (DE) 10 2019 103 997.5

(51) Int. Cl. E05D 5/12

(52) U.S. Cl. CPC E05D 5/125; E05D 2005/145; E05Y 2900/20

(57) ABSTRACT

A hinge arrangement for a switch cabinet, having a switch cabinet body and a switch cabinet door which is fastened thereto via at least two hinges arranged vertically one above the other, at least a first of the hinges, which is arranged above a second of the hinges, having a first body-side hinge half with a first hinge pin which projects vertically upwards from a first pin seat, onto which a first door-side hinge half is fitted, wherein the first hinge pin has an auxiliary mounting position in which it projects from the first pin seat by a first length which is greater than a second length by which a second hinge pin of a second body-side hinge half of the second hinge projects from its second pin seat. A corresponding method is also described.

### CROSS-REFERENCE TO RELATED APPLICATIONS

This application is a U.S. National Phase Application under 35 USC 371 of International Application No. PCT/DE2020/100011, filed on Jan. 9, 2020, which claims the benefit of German Application No. 10 2019 103 997.5, filed on Feb. 18, 2019. The entire disclosures of the above applications are incorporated herein by reference.

### BACKGROUND

This section provides background information related to the present disclosure which is not necessarily prior art.

### TECHNICAL FIELD

The invention is based on a hinge arrangement for a switch cabinet, with a switch cabinet body and a switch cabinet door fastened thereto by means of at least two hinges arranged vertically one above the other, at least a first of the hinges, which is arranged above or below a second of the hinges, having a first body-side hinge half with a first hinge pin which projects vertically upwards from a first pin seat and onto which a first door-side hinge half is fitted. Such a hinge arrangement is known from DE 10 2016 117 378 B3. A similar hinge arrangement is also shown in DE 10 2017 108 586 B3.

### DISCUSSION

The hinge arrangements known from the prior art have the disadvantage that the switch cabinet door sometimes has a considerable weight and is bulky to handle, which can cause difficulties when manually attaching the switch cabinet door to the switch cabinet body. In addition, switch cabinets are often hinged to the cabinet body with more than two hinges. Often there are at least three hinges arranged vertically one above the other. Accordingly, for the switch cabinet door to be attached to the switch cabinet body, it is necessary that three door-side hinge halves arranged vertically one above the other, each of which has a hinge pin receptacle, are simultaneously brought into alignment with three body-side hinge halves, in particular with their respective hinge pins, so that the switch cabinet door can be lowered via the hinge pin receptacles onto the hinge pins arranged one above the other.

### SUMMARY

This section provides a general summary of the disclosure, and is not a comprehensive disclosure of its full scope or all of its features.

It is therefore one aspect of the invention to further develop a hinge arrangement of the type described at the beginning in such a way that it enables easy mounting of the switch cabinet door on the switch cabinet body.

Accordingly, the first hinge pin is provided with an auxiliary mounting position in which it protrudes from the first pin seat by a first length greater than a second length by which a second hinge pin of a second body-side hinge half of the second hinge protrudes from its second pin seat.

This means, for example, that during the assembly process the hinge halves of an upper hinge can first be engaged with the hinge pin in the auxiliary mounting position before the hinge halves of at least one further hinge can be engaged with each other, if necessary after a supplementary alignment of the switch cabinet door in relation to the switch cabinet body. Since the hinge pin in the auxiliary mounting position projects further from its pin seat than the hinge pin of a further body-side hinge half projects from its respective pin seat, it is possible for the body-side hinge half with the hinge pin in the auxiliary mounting position to be brought into engagement with its associated door-side hinge half without the further body-side hinge half necessarily also having to be brought into engagement with its associated door-side hinge half.

In order to achieve that the hinges of the hinge arrangement and in particular the body-side hinge halves can be formed as identical parts, it can be provided that the first hinge pin is accommodated in the first pin seat adjustably in vertical direction between the auxiliary mounting position and an end position, wherein the first hinge pin in the end position protrudes from the first pin seat by a third length which is smaller than the first length. Here, it may be provided that the third length is just substantially identical to the first length. In this embodiment, it may be provided that also during the assembly process of the switch cabinet door to the switch cabinet body, for example, a lowermost door-side hinge half with a hinge pin adjustable in the vertical direction is used exclusively in the end position of the hinge pin, since no auxiliary mounting position is required for this body-side hinge half for the assembly of the switch cabinet door to the switch cabinet body if the other body-side hinge halves each have an auxiliary mounting position. However, the body-side hinge half without a mounting aid position does not necessarily have to be a lowermost body-side hinge half. Any other body-side hinge half can also have this function.

At least the first hinge pin may have a stop via which the first hinge pin abuts the first pin seat in the end position, the stop being arranged a distance above the first pin seat in the auxiliary mounting position. The stop can be a flange projecting on the outer circumference of the hinge pin, preferably a circumferentially projecting flange.

In the end position, the stop can be accommodated in a recess on an upper side of the first pin seat. In the end position, the stop can be aligned with an upper contact surface of the first bolt seat so that the stop and the upper contact surface form a support for the first door-side hinge half.

The first hinge pin may have another auxiliary mounting position in which the first hinge pin protrudes from the first pin seat by a fourth length greater than the first length.

The first hinge pin may assume a detent position in at least one auxiliary mounting position and, if present, at least one additional auxiliary mounting position.

In the detent position, a spring element applied to at least one side of the first pin seat can engage in a latching notch on the outer circumference of the first hinge pin. In this case, the first hinge pin can rest on the spring element with a run-up slope in a further auxiliary mounting position. The run-up slope can be formed at the end of the pin over which the pin extends into a pin channel of the pin seat.

The spring element may be disposed in a spring receptacle opening into a first bolt seat channel of the first bolt seat and accessible from the exterior of the first bolt seat. The spring receptacle may exhibit opposing and spaced apart bearing surfaces for a clamping end of the spring element. In at least one detent position, the clamping end may abut a first of the two bearing surfaces that opens into the bolt seat channel.

The first hinge pin may have, in a position different from one of the detent positions, the clamping end pressed by the first hinge pin under a bias against the second of the two bearing surfaces disposed at a distance from the pin seat channel.

The first hinge pin may have a circumferential notch on the outer circumference of its upper end, with which the first hinge pin protrudes from the first pin seat in the end position. The notch can serve to facilitate displacement of the hinge pin from the end position into at least one auxiliary mounting position, for which purpose the hinge pin must be pulled out of its pin seat at least partially.

According to another aspect, a method for mounting a switch cabinet door to a switch cabinet body using a hinge arrangement of the type previously described is described. The method comprises:
Positioning the hinge pin of a first body-side hinge half, which is arranged above or below a second body-side hinge half, in an auxiliary mounting position in which the hinge pin of the first body-side hinge half protrudes from its pin seat by a length which is greater than a length by which the hinge pin of the second body-side hinge half protrudes from its pin seat;
Attachment of the switch cabinet door to the switch cabinet body, wherein the first door-side hinge half, which is arranged above a second door-side hinge half, is only partially pushed onto the hinge pin of the first body-side hinge half, wherein the second door-side hinge half is arranged completely above the second body-side hinge half;
Aligning the enclosure door with respect to the enclosure body so that a hinge pin receiver of the second door-side hinge half is aligned with the hinge pin of the second body-side hinge half; and
Lowering the switch cabinet door, whereby the second door-side hinge half is pushed onto the hinge pin of the second body-side hinge half.

When attaching the switch cabinet door to the switch cabinet body, the first door-side hinge half can be pushed onto the hinge pin up to a stop on the outer circumference of the hinge pin. For this purpose, when positioning the hinge pin, the hinge pin can be arranged in its auxiliary mounting position with the stop spaced from an upper side of a pin seat of the door-side hinge halves.

When the switch cabinet door is lowered, the first hinge pin can be transferred from the auxiliary mounting position to the end position. For this purpose, the first door-side hinge half can come into contact with the stop or flange provided on the outer circumference of the first hinge pin, so that when the switch cabinet door is lowered further, the hinge pin is pushed into its hinge pin seat by the weight of the switch cabinet door until the stop reaches an upper side of the pin seat, against which the stop comes into contact.

The positioning may include positioning a first hinge pin in a first assembly assist position and positioning a second hinge pin, disposed below the first hinge pin and above a lowermost hinge pin, in a second assembly assist position, wherein the second hinge pin protrudes from its pin seat by a length that is less than a length by which the first hinge pin protrudes from its pin seat and that is greater than a length by which the lowermost hinge pin protrudes from its lowermost pin seat.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Further details of the invention are explained with reference to the figures below. Thereby shows:

FIG. 1 a switch cabinet comprising a hinge arrangement according to the state of the art;

FIG. 2 in a perspective view of a body-side hinge half according to an embodiment of the invention;

FIG. 3 a sectional view of a body-side hinge half in a first auxiliary mounting position;

FIG. 4 an embodiment according to FIG. 3 in a second auxiliary mounting position;

FIG. 5 the embodiment according to FIGS. 3 and 4 in the end position;

FIG. 6 a horizontal cross-section through another embodiment of a body-side hinge half; and

FIG. 7 an embodiment of a hinge pin compatible with the hinge halves according to FIGS. 2 to 6.

### DETAILED DESCRIPTION

Example embodiments will now be described more fully with reference to the accompanying drawings.

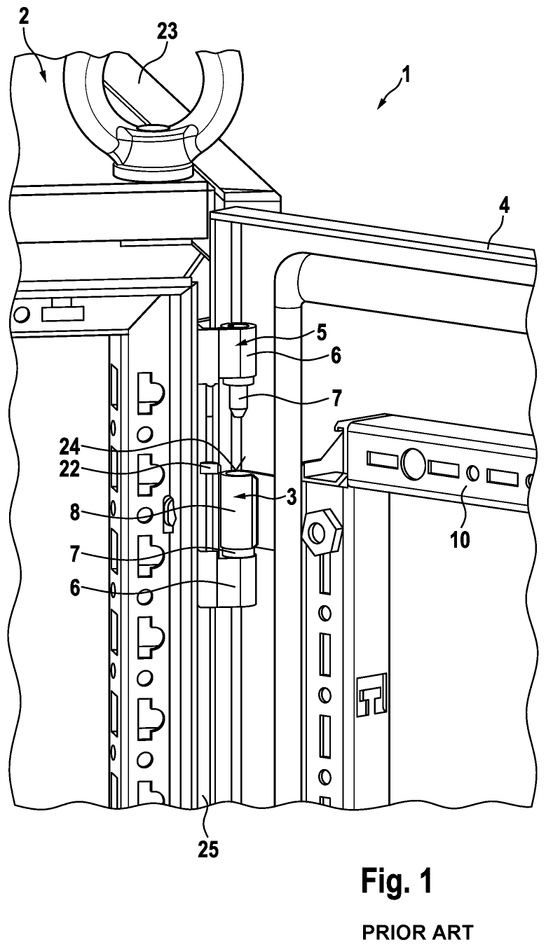

FIG. 1 shows a switch cabinet 1 according to an embodiment of the prior art. The switch cabinet 1 has a switch cabinet body 2 which essentially comprises a frame 25 and flat parts fixed thereto, for example a roof element 2, side elements 23 and a door element 4. The door element 4 is fixed to a vertical profile of the frame 25 by means of an arrangement of three hinges 3 of identical design and arranged vertically one above the other. The hinge 3 has a hinge half 5 on the door side with two opposing pin seats 6, from each of which a hinge pin 7 projects, which face each other. Accordingly, the hinge 3 is designed as a so-called lift-off hinge. The door-side hinge half 8 is a bent sheet metal plate which is welded to an inner side of the door element 4. The hinge pins 7 are received in their respective pin seat 6 in a non-adjustable manner, for example pressed or welded therein. To prevent unintentional unhinging of the door 4, the hinge half 5 on the cabinet side has a lift-off protector 22. Further details of the prior art switch cabinet 1 shown in FIG. 1 are described in DE 10 2016 117 378 B3.

Standard switch cabinets 1 normally have a height of approximately 2 meters, whereby the switch cabinet door 4 also extends over the entire height of the switch cabinet 1 in order to achieve the largest possible opening dimension, so that the switch cabinet door 4 must be aligned over its entire vertical length parallel to the switch cabinet frame 25, in particular to a vertical profile of the latter, to which the door 4 can be fixed via three hinges 3 arranged equidistantly to one another, in order to suspend the switch cabinet door 4. In the embodiment according to FIG. 1, three hinge halves 5 on the cabinet side are thus fixed equidistantly to the switch cabinet frame, while the switch cabinet door 4 has three welded-on hinge halves 8 on its inside, shown in FIG. 1, equidistantly spaced at the same distance from one another, which, in order to hang the switch cabinet door 4 in the body 2, must be simultaneously brought into alignment with a respective hinge pin 7 in order to place them on the hinge pins 7. This involves considerable assembly work, since the switch cabinet doors 4, which are designed as sheet metal parts, can weigh a considerable amount with an internal door tube frame 10 and possibly other attachments.

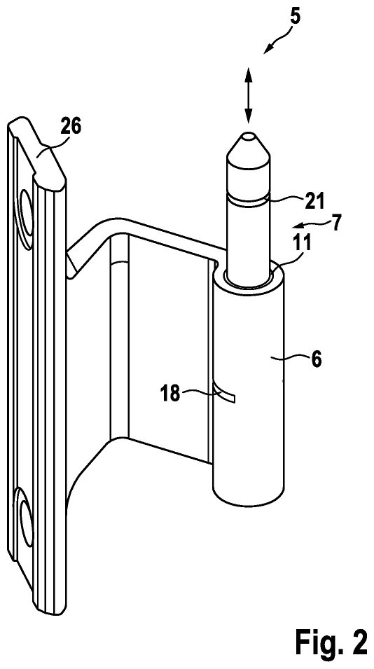

To solve this problem, the invention proposes a hinge arrangement which differs from hinge arrangements known from the prior art in that the hinge pin 7 of at least one hinge 3 has an auxiliary mounting position in which it protrudes from its first pin seat 6 by a length which is greater than a length by which a second hinge pin 7 of a second body-side hinge half 5 of a second hinge 3 protrudes from its pin seat 6. Such an enclosure-side hinge half 5 is shown in FIG. 2 and may, for example, be adapted to replace the hinge half 5 as shown in the prior art embodiment according to FIG. 1. The door-side hinge halves can be adopted identically. In particular, the body-side hinge halves described below are compatible with the door-side hinge half shown in FIG. 1. For ease of illustration, therefore, only the body-side hinge half 5 is shown in FIG. 2 and the following illustrations of exemplary embodiments.

Analogous to the body-side hinge half 5 known from the prior art, the hinge half 5 according to the invention as shown in FIG. 2 has a mounting flange 26 by means of which the body-side hinge half 5 can be fixed to a vertical profile of a frame of a switch cabinet. Via a curved web, a bolt seat 6 is connected to the mounting flange 26 at a distance. In the bolt seat 6, the hinge bolt is accommodated adjustably in its vertical direction. At its upper end, the bolt 7 has a notch 21 which is intended to facilitate manual adjustment of the bolt 7 in the vertical direction. The bolt seat 6 has a spring receptacle 18 at its outer periphery, which is an opening through the bolt seat 6 through which an outer periphery of the bolt 7 is accessible from outside the bolt seat 6. A spring element 14, which is not recognizable, is accommodated in the spring receptacle 18 and engages in likewise not recognizable detent notches on the outer circumference of the hinge pin 7 so that the hinge pin 7 assumes a defined detent position in its at least one auxiliary mounting position. This is explained in more detail with reference to the following figures.

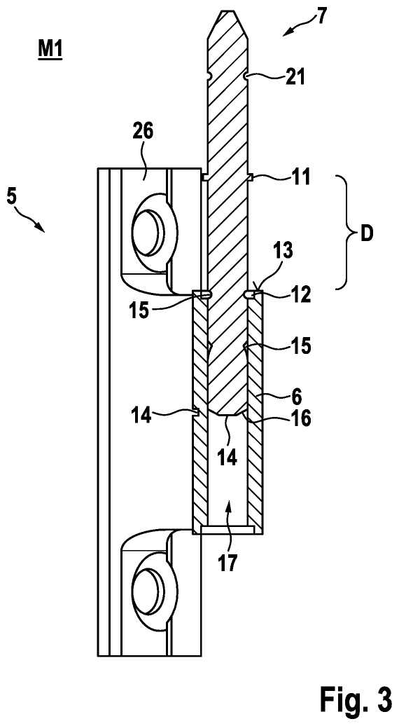

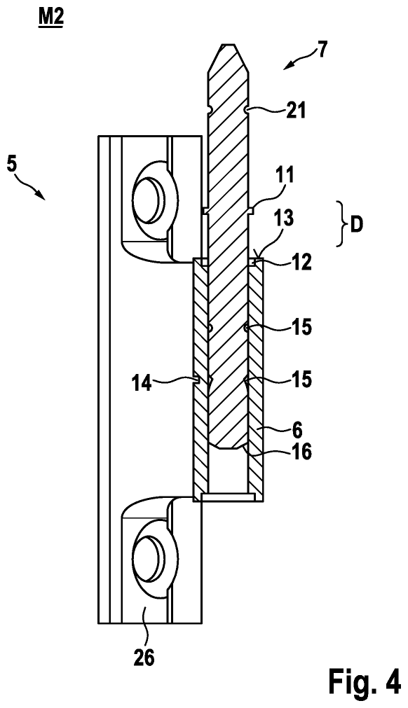

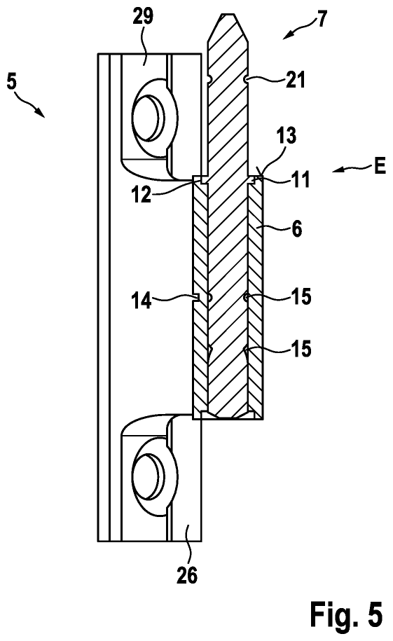

FIGS. 3 to 5 show an embodiment of a body-side hinge half 5 with three different setting positions of the hinge pin 7. The three setting positions can correspond, for example, to the setting positions of the hinge pin 7 of a switch cabinet body prior to assembly of a switch cabinet door, which has three body-side hinge halves 5 of the same type arranged one above the other. For example, an upper body-side hinge half 5 could have a setting position of the hinge pin 7 as shown in FIG. 3. A middle body-side hinge half could have a setting position of the hinge pin 7 as shown in FIG. 4. A lower hinge half on the body side could have a setting position of the hinge pin 7 as shown in FIG. 5.

FIG. 3 shows the body-side hinge half 5 in a maximally extended detent position corresponding to a first auxiliary mounting position M1 in which, for example, the stop 11 is also at a distance D from the upper side 13 of the bolt seat 6 which is greater than the distance D in the further auxiliary mounting position M2 of the bolt 7 as shown in FIG. 4. If, for example, the body-side hinge halves 5 shown in FIGS. 3 to 5 are arranged vertically one above the other in their respective setting position on a vertical profile of a switch cabinet frame profile in the sequence described above, then when the switch cabinet door is set in place the uppermost door-side hinge half can first be placed on the upper free end of the hinge pin 7 as shown in FIG. 3, while the door-side hinge halves located below it are not yet engaged with the hinge pin 7 assigned to them in each case. By lowering the switch cabinet door relative to the switch cabinet body, the middle door-side hinge half would then first engage with the hinge pin 7 of the middle body-side hinge half 5 as shown in FIG. 4, until further lowering of the switch cabinet door results in the lowest door-side hinge half also engaging with the pin 7 with the lower body-side hinge half as shown in FIG. 5.

Lowering the door also causes the uppermost door-side hinge half to step on the stop 11 of the uppermost body-side hinge half, thereby gradually inserting the pin 7 further into its pin seat 6, in particular the pin seat channel 17. Further lowering of the door then results in the middle door-side hinge half also stepping on the stop 11 of the middle body-side hinge half as shown in FIG. 4 and likewise displacing the bolt 7 further downwards. The lowermost body-side hinge half 5 as shown in FIG. 5 already has the hinge pin 7 in its end position E, in which the hinge pin 7 is inserted with its stop 11, which is designed as a circumferential ring flange, in a recess 12 on the upper side 13 of the pin seat 6. In this setting position, an upper side of the flange 11 is aligned with the upper side 13 of the bolt seat 6, so that a flat bearing surface is created for the hinge half on the door side. Furthermore, the spring element 14 engages the upper of the two detent notches 15 so that the hinge pin 7 is locked in the end position E.

Also in the auxiliary mounting positions M1, M2 of the hinge pin according to FIGS. 3 and 4, the hinge pin 7 has in each case a position predefined via the spring element 14, whereby the spring element 14 in the auxiliary mounting position M1 according to FIG. 3 forms a bearing surface for the hinge pin 7, on which the hinge pin 7 rests via an end-side run-up slope 16.

In the second auxiliary mounting position M2 according to FIG. 4, the spring element 14 engages in a detent notch 15 on the outer circumference of the hinge pin 7, namely in the lower of the two detent notches 15 arranged one above the other.

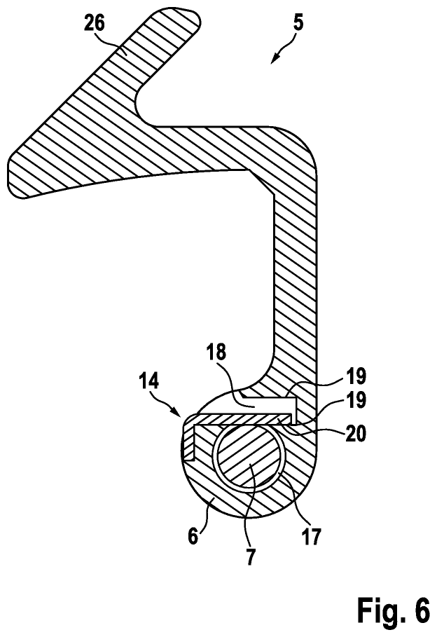

In FIG. 6 it is shown that the spring element 14 is arranged in a spring receptacle 18, which opens into a first bolt seat channel 17 (cf. also FIG. 3) of the bolt seat 6 and is accessible from an outer side of the bolt seat 6. The spring receptacle 18 has opposing and spaced-apart bearing surfaces 19 for a clamping end 20 of the spring element 14. Here, it is provided that in the detent positions the clamping end 20 rests against a bearing surface 19 which opens into the bolt seat channel 17. In a position different from the detent position, the clamping end is pressed by the first hinge pin under a preload against the opposite bearing surface 19, which is arranged at a distance from the pin seat channel 17.

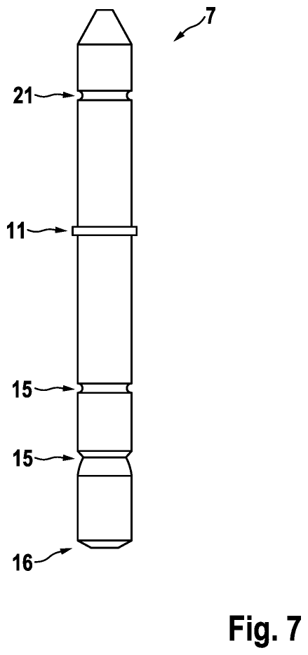

FIG. 7 illustrates an exemplary embodiment of a hinge pin 7. Viewed from top to bottom, this has a notch 21 at its upper end which serves as a pull-out aid. Below this, the hinge pin 7 has, at a distance, a circumferential flange which forms a stop 11 via which, in cooperation with an upper side of a body-side hinge half, a defined end position of the hinge pin 7 is determined with respect to the pin seat. Below this, the hinge pin 7 has two latching notches 15 in which a spring element of the pin seat can engage in order to lock the hinge pin 7 in the end position or the second auxiliary mounting position M2 (cf. FIGS. 4 and 5). At the lower end, the hinge pin 7 has a run-up slope 16 via which the hinge pin 7 rests on the spring element in the first auxiliary mounting position M1 (cf. FIG. 3).

The features of the invention disclosed in the foregoing description, in the drawings as well as in the claims may be essential to the realization of the invention both individually and in any combination.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A hinge arrangement for a switch cabinet comprising a switch cabinet body and a switch cabinet door fastened thereto via at least two hinges arranged vertically one above the other, at least a first one of the hinges, which is arranged above a second one of the hinges, having a first body-side hinge half with a first hinge pin projecting vertically upwards from a first pin seat onto which a first door-side hinge half is fitted, wherein the first hinge pin has an auxiliary mounting position in which it projects from the first pin seat by a first length which is greater than a second length by which a second hinge pin of a second body-side hinge half of the second hinge protrudes vertically upwards from its second pin seat, wherein the first hinge pin is accommodated in the first pin seat so as to be displaceable in the vertical direction between the auxiliary mounting position and an end position, wherein the first hinge pin protrudes from the first pin seat in the end position by a third length which is substantially identical to the second length, and wherein the first hinge pin assumes a detent position in the auxiliary mounting position.

2. (canceled)

3. (canceled)

4. The hinge arrangement according to claim 1, in which at least the first hinge pin has a stop via which the first hinge pin bears against the first pin seat in the end position (E), the stop being arranged a distance (D) above the first pin seat in the auxiliary mounting position.

5. The hinge arrangement of claim 4, wherein the stop is a flange projecting on the outer periphery of the hinge pin, preferably a circumferentially projecting flange.

6. A hinge arrangement according to claim 4, wherein the stop in the end position (E) is received in a recess on an upper side of the first pin seat.

7. The hinge arrangement of claim 6, wherein the stop is aligned with an upper abutment surface of the first pin seat in the end position (E) so that the stop and the upper abutment surface form a support for the first door-side hinge half.

8. The hinge arrangement according to claim 1, wherein the first hinge pin has a further auxiliary mounting position (M2) in which the first hinge pin protrudes from the first pin seat by a fourth length smaller than the first length.

9. The hinge arrangement according to claim 1, in which the first hinge pin assumes a detent position in at least one further auxiliary mounting position.

10. The hinge arrangement according to claim 9, in which, in the detent position, a spring element fixed to the first pin seat at least on one side engages in a latching notch on the outer circumference of the first hinge pin.

11. The hinge arrangement according to claim 9, wherein the first hinge pin rests on the spring element in a further auxiliary mounting position with a run-up slope.

12. The hinge arrangement according to claim 10, wherein the spring element is arranged in a spring receptacle opening into a first pin seat channel of the first pin seat and accessible from the outside of the first pin seat.

13. The hinge arrangement of claim 12, wherein the spring receptacle includes opposing and spaced apart bearing surfaces for a clamping end of the spring element, wherein in at least one of the detent positions the clamping end abuts a first of the two bearing surfaces that opens into the pin seat channel.

14. The hinge arrangement according to claim 13, wherein said first hinge pin in a position different from one of said detent positions, said clamping end is pressed by said first hinge pin under a bias against the second of said two bearing surfaces located at a distance from said pin seat channel.

15. The hinge arrangement according to claim 2, wherein the first hinge pin has a circumferential notch at the outer periphery of its upper end with which the first hinge pin protrudes from the first pin seat in the end position (E).

16. A method for mounting a switch cabinet door to a switch cabinet body using a hinge arrangement according to claim 1, the method comprising:
Positioning of the hinge pin of a first body-side hinge half, which is arranged above a second body-side hinge half, in an auxiliary mounting position, in which the hinge pin of the first body-side hinge half projects from its pin seat by a length which is greater than a length by which the hinge pin of the second body-side hinge half projects from its pin seat;
Attachment of the switch cabinet door to the switch cabinet body, wherein the first door-side hinge half, which is arranged above a second door-side hinge half, is pushed only partially onto the hinge pin of the first body-side hinge half, wherein the second door-side hinge half is arranged completely above the second body-side hinge half;
Aligning the switch cabinet door with respect to the switch cabinet body so that a hinge pin receiver of the second door-side hinge half is aligned with the hinge pin of the second body-side hinge half; and
Lowering the switch cabinet door, whereby the second door-side hinge half is pushed onto the hinge pin of the second body-side hinge half, wherein the first hinge pin is transferred from the auxiliary mounting position to the end position.

17. (canceled)

18. The method of claim 16, wherein said positioning comprises positioning a first hinge pin in a first auxiliary mounting position and positioning a second hinge pin located below the first hinge pin and above a lowermost hinge pin, in a second auxiliary mounting position, the second hinge pin protruding from its pin seat by a length that is less than a length by which the first hinge pin protrudes from its pin seat and that is greater than a length by which the lowermost hinge pin protrudes from its lowermost pin seat.
